(19) United States
(12) Patent Application Publication
(10) Pub. No.: US 2026/0131562 A1
(43) Pub. Date: May 14, 2026

(54) LAMINATE MANUFACTURING SYSTEM

(71) Applicant: THE JAPAN STEEL WORKS, LTD., Tokyo (JP)

(72) Inventors: Takayuki YAMAMOTO, Tokyo (JP); Takashi NAGAI, Tokyo (JP); Naoki UEDA, Tokyo (JP)

(21) Appl. No.: 19/337,240

(22) Filed: Sep. 23, 2025

(30) Foreign Application Priority Data
Nov. 13, 2024 (JP) 2024-198245

(51) Int. Cl. B32B 37/02; B32B 37/10

(52) U.S. Cl. CPC B32B 37/02; B32B 37/1018; B32B 37/1054; B32B 2307/7375; B32B 2309/68

(57) ABSTRACT

There is a problem in a related laminate manufacturing system that it a lot of installation space. A laminate manufacturing system according to the present disclosure includes: a pair of carrier films configured to convey a laminated body from one side to another side of the laminate manufacturing system; a film unwinding apparatus configured to unwind the carrier film; a laminate manufacturing apparatus that is disposed on the other side of the film unwinding apparatus and presses the laminated body by a pressurizing mechanism in a chamber whose interior is depressurized; and a film winding apparatus that is disposed on the other side of the laminate manufacturing apparatus and winds the carrier film, wherein a vacuum pump for depressurizing the interior of the chamber is disposed below the film unwinding apparatus.

### INCORPORATION BY REFERENCE

This application is based upon and claims the benefit of priority from Japanese patent application No. 2024-198245, filed on November 13, 2024, the disclosure of which is incorporated herein in its entirety by reference.

### BACKGROUND

The present disclosure relates to, for example, a laminate manufacturing system that includes a laminate manufacturing apparatus configured to manufacture a laminate product by applying a pressing force to a laminated body.

Japanese Patent No. 6900138 discloses a laminate manufacturing system including a film unwinding apparatus configured to supply a laminated body placed on a carrier film to a laminate manufacturing apparatus, a laminate manufacturing apparatus that applies a pressing force to the laminated body, and a film winding apparatus configured to transport the laminated body placed on the carrier film from the laminate manufacturing apparatus.

### SUMMARY

A pressing force generation mechanism that generates a pressing force of the laminate manufacturing apparatus disclosed in Japanese Patent No. 6900138 is driven by a hydraulic pump. Further, a chamber of the laminate manufacturing apparatus disposed at a position which is the closest to the film unwinding apparatus of the laminate manufacturing system disclosed in Japanese Patent No. 6900138 needs to be maintained in a vacuum state during the operation, and a vacuum pump is connected to the laminate manufacturing apparatus. These hydraulic pump and vacuum pump are often disposed in the laminate manufacturing apparatus or on a back side of the film unwinding apparatus, which has been a factor for requiring a lot of installment space in the laminate manufacturing system.

The present disclosure has been made in view of the aforementioned circumstances, and an object of the present disclosure is to save a space in a laminate manufacturing system.

A laminate manufacturing system according to the present disclosure includes: a pair of carrier films configured to convey a laminated body from one side to another side of the laminate manufacturing system; a film unwinding apparatus configured to unwind the carrier film; a laminate manufacturing apparatus that is disposed on the other side of the film unwinding apparatus and presses the laminated body by a pressurizing mechanism in a chamber whose interior is depressurized; and a film winding apparatus that is disposed on the other side of the laminate manufacturing apparatus and winds the carrier film, in which a vacuum pump for depressurizing the interior of the chamber is disposed below the film unwinding apparatus.

In the laminate manufacturing system according to the present disclosure, a vacuum pump is disposed below the film unwinding apparatus, whereby an installment space in the laminate manufacturing system can be further reduced.

According to the laminate manufacturing system of the present disclosure, it is possible to save an installment space in the laminate manufacturing system.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing one example of a configuration of a laminate manufacturing system according to a first embodiment;

FIG. 2 is a diagram showing one example of disposition of a vacuum pump and a storage box according to the first embodiment; and

FIG. 3 is a diagram showing one example of a configuration of a laminate manufacturing apparatus according to the first embodiment.

### DESCRIPTION OF EMBODIMENTS

To clarify the description, the description and drawings below are suitably omitted or simplified. In the respective drawings, the same elements are given the same reference symbols, and the repeated description are omitted when appropriate.

### First Embodiment

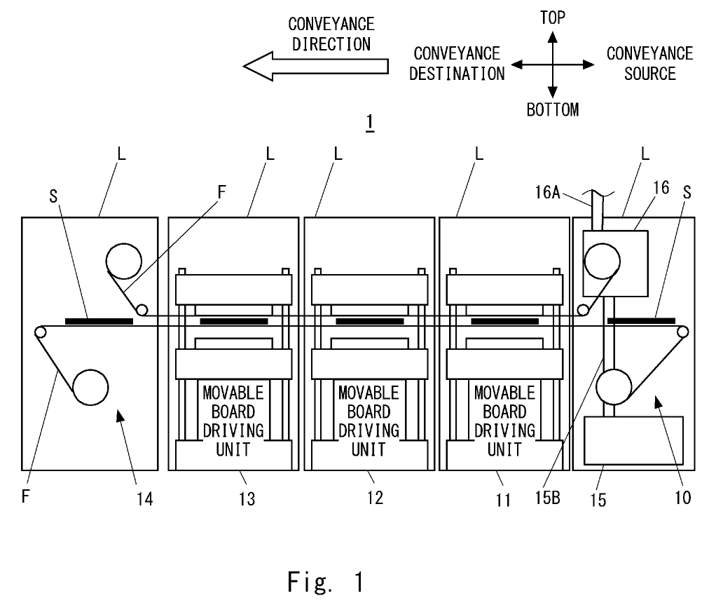

As shown in FIG. 1, a laminate manufacturing system 1 according to a first embodiment conveys a laminated body S, which is sandwiched by a pair of carrier films F, from one side to the other side of the laminate manufacturing system 1 in a state in which a laminate film (not shown) is placed on the laminated body S. Further, the laminate manufacturing system 1 includes a film unwinding apparatus 10 that supplies the carrier film F and a film winding apparatus 14 that recovers the carrier film F. Further, the laminate manufacturing system 1 includes a vacuum laminating apparatus 11 that performs a laminate manufacturing process for applying pressure to the laminated body S which is sandwiched by a pressurizing mechanism (described later) so as to laminate at least one surface of the laminated body S with the laminate film. The laminate manufacturing system 1 according to the first embodiment further includes flattening press apparatuses 12 and 13. Then, in the laminate manufacturing system 1, the vacuum laminating apparatus 11 and the flattening press apparatuses 12 and 13 are disposed between the film unwinding apparatus 10 and the film winding apparatus 14 in such a way that they are adjacent to each other in this order. The film unwinding apparatus 10 unwinds the carrier film F in a state in which the laminated body S is placed on the carrier film F. Further, the film winding apparatus 14 removes the laminated body S pressurized by the vacuum laminating apparatus 11 and the flattening press apparatuses 12 and 13 by winding the carrier film F. That is, a direction from the film unwinding apparatus 10 to the film winding apparatus 14 is a conveyance direction of the laminated body S.

Then, in the laminate manufacturing system 1, the laminated body S is pressurized by each of the vacuum laminating apparatus 11 and the flattening press apparatuses 12 and 13 while being moved through each of these apparatuses, thereby manufacturing a laminate product. A primary product in which the laminate film is laminated on the laminated body S is manufactured by the vacuum laminating apparatus 11, and a secondary product in which the flatness of the laminated surface of the laminate film of the primary product is improved is manufactured in the flattening press apparatus 12 and the flattening press apparatus 13. By performing stepwise manufacturing in this manner, the flatness of the surface of the laminate film of the laminate product can be increased. Here, a configuration in which a movable board (described later) is pressed against a fixed board (described later) by a pressing force generation mechanism (described later) incorporated into a driving unit (e.g., a movable board driving unit) in the vacuum laminating apparatus 11 is the same as that in the flattening press apparatuses 12 and 13. On the other hand, a pressurization control method in the vacuum laminating apparatus 11 and that in the flattening press apparatuses 12 and 13 may be different from each other. Further, while the vacuum laminating apparatus 11 needs a chamber (described later), the flattening press apparatuses 12 and 13 may not include a chamber.

That is, the laminate manufacturing system 1 according to the first embodiment includes a plurality of laminate manufacturing apparatuses (that is, the vacuum laminating apparatus 11 and the flattening press apparatuses 12 and 13). Further, the plurality of laminate manufacturing apparatuses each include a fixed board, a movable board provided in a position opposed to the fixed board, and a pressing force generation mechanism that makes the movable board come close to the fixed board. Accordingly, the fixed board and the movable board sandwich and press the laminated body S.

The laminate manufacturing system 1 according to the first embodiment further includes a vacuum pump 15 for putting a chamber (described later) of the vacuum laminating apparatus 11 in a vacuum state. In the present disclosure, the vacuum state indicates a state in which the pressure in the chamber is depressurized down to a predetermined value. Further, as shown in FIG. 1, the vacuum pump 15 is disposed below the film unwinding apparatus 10 in the rack L. Further, the vacuum pump 15 is disposed in such a way that at least a part of it is positioned in the rack L in which the film unwinding apparatus 10 is placed. In other words, the vacuum pump 15 is disposed in such a way that a surface on a front side of the vacuum pump 15 is positioned in the rack L. While a surface on a back side of the vacuum pump 15 is preferably positioned in the rack L, it may instead be positioned in the outside of the rack L, that is, on the back side of the rack L.

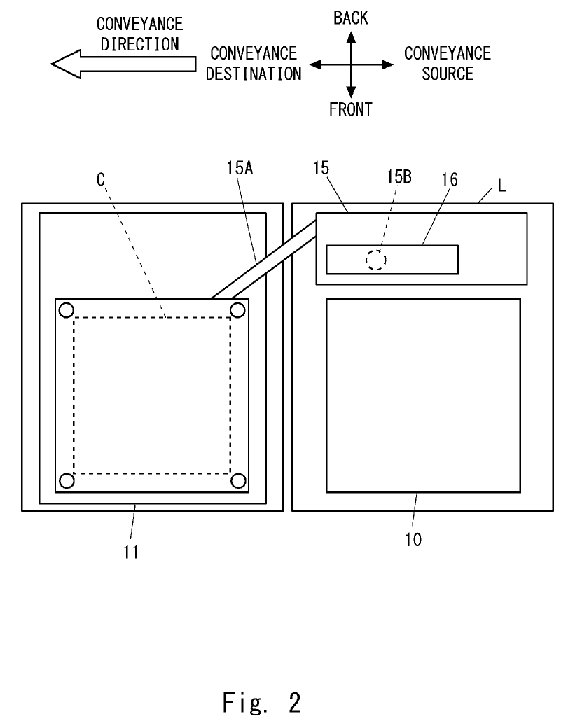

In the example shown in FIG. 2, the vacuum pump 15 is disposed in the rack L in such a way that the surface on the front side of the vacuum pump 15 is positioned at the center of the film unwinding apparatus 10 or on a back side with respect to the center thereof. Further, the vacuum pump 15 is disposed in such a way that the surface on the back side of the vacuum pump 15 is at the same position as the surface on the back side of the vacuum laminating apparatus 11 or on the front side of the surface on the back side of the vacuum laminating apparatus 11. The vacuum pump 15, which is coupled to the chamber C of the vacuum laminating apparatus 11 by a suction pipe 15A, sucks gas in the chamber C. Specifically, the suction pipe 15A extends obliquely, as viewed from above, from the back side of the chamber C, then extends downwardly, and then coupled to the vacuum pump 15 so as to couple the chamber C to the vacuum pump 15 in a short distance. In other words, at least a part of the suction pipe 15A extends obliquely with respect to the conveyance direction of the laminated body S. Note that the suction pipe 15A may have a configuration in which a plurality of pipes are coupled to each other. The form and the shape of the pipes are not particularly limited, and may be pipe-shaped members or may be holes (internal pipes) provided so as to penetrate through the movable board or the fixed board of the vacuum laminating apparatus 11. Further, the pipes may have a shape in which at least a part thereof is bent or curved, a bellows shape, or a spiral shape. The pipes may further include a movable part that can move so as to follow a change in a position where they are coupled to each other or an operation thereof. That is, the movable part of each pipe may extend or retract in one direction, rotate, turn, curve, or bend. It is preferable that the internal volume of the rack L be as small as possible. Therefore, the interior of the rack L is narrow since all kinds of components, elements, and wires are disposed to minimize gaps as much as possible. Since the suction pipe 15A includes the above-described pipes, the insertion path of the suction pipe 15A can be efficiently set, and the length of the suction pipe 15A can be further reduced.

The laminate manufacturing system 1 according to the first embodiment further includes a storage box 16 that stores pneumatic equipment (not shown) configured to control the pressure of the pressurizing mechanism of the vacuum laminating apparatus 11 and the flattening press apparatuses 12 and 13. The gas exhausted from the pneumatic equipment flows into the storage box 16. Further, the storage box 16 is disposed in the rack L in which the film unwinding apparatus 10 is placed. Further, the storage box 16 is preferably disposed in the upper part of the rack L. Then, an exhaust pipe 15B of the vacuum pump 15 is coupled to the storage box 16, and the gas exhausted from the vacuum pump 15 flows into the storage box 16. Specifically, the exhaust pipe 15B extends substantially straight upwardly from the vacuum pump 15, and is coupled to the storage box 16. Further, the exhaust pipe 16A of the storage box 16 is connected to the outside of a clean room where the laminate manufacturing system 1 is installed. Accordingly, the gas exhausted from the vacuum pump 15 is exhausted to the outside of the clean room through the exhaust pipe 16A along with the gas exhausted from the pneumatic equipment.

As the components that are necessary for the laminate manufacturing system 1, besides the film unwinding apparatus 10, the vacuum pump 15, and the storage box 16, pipes, wires, equipment, a monitor, a control panel, elements, a frame, and the like that are not shown are accommodated in the space surrounded by the rack L. However, when the rack L is made large in order to accommodate these components, the footprint of the laminate manufacturing system 1 becomes large and the production efficiency is decreased. Therefore, it is preferable that the volume rate occupied by the space of a void, excluding the components, in the space surrounded by the rack L be as small as possible, preferably 70% or less, and more preferably 50% or less.

In the viewpoint of reducing the footprint of the laminate manufacturing system 1, it is desirable that the width from the front side to the back side of the rack L is minimized as much as possible. Specifically, it is desired to minimize the width of the film unwinding apparatus 10 as much as possible in accordance with the width of the carrier film F. Therefore, it is preferable that the width from the front side to the back side of the rack L be 1.5 times or more but 4.5 times or less of the width of the carrier film F, and more preferably 1.5 times or more but 3.5 times or less of the width of the carrier film F.

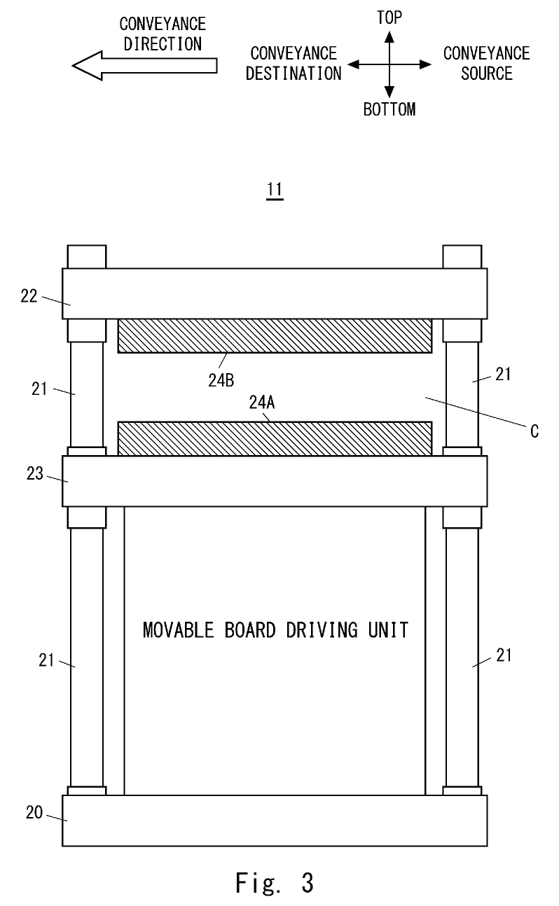

As described above, since the configuration in which the movable board and the fixed board press the laminated body S due to the pressing force by the pressing force generation mechanism of the vacuum laminating apparatus 11 and the flattening press apparatuses 12 and 13 is the same, in the following description, a basic configuration of the laminate manufacturing apparatus will be described using the example of the vacuum laminating apparatus 11 with reference to FIG. 3.

As shown in FIG. 3, the vacuum laminating apparatus 11 includes a base board 20, tie bars 21, a fixed board 22, and a movable board 23. In the vacuum laminating apparatus 11, the tie bars 21 are fixed to the four corners of the base board 20, these tie bars 21 are connected to insertion holes of the four corners of the movable board 23 in such a way that the movable board 23 can be vertically moved, and these tie bars 21 are fixed to the four corners of the fixed board 22. Accordingly, the movable board 23 is incorporated between the base board 20 and the fixed board 22 so that the movable board 23 can be vertically moved. Then, in the example shown in FIG. 3, an upper pressurizing plate 24B is attached to the fixed board 22. Further, a lower pressurizing plate 24A is attached to the movable board 23. The upper pressurizing plate 24B and the lower pressurizing plate 24A apply pressure to the laminated body S on which a laminate film (not shown) is placed. That is, the base board 20, the tie bars 21, the fixed board 22, the movable board 23, the upper pressurizing plate 24B, and the lower pressurizing plate 24A form a pressurizing mechanism. Further, the space between the fixed board 22 and the movable board 23 is a chamber C sealed as the movable board 23 is raised. Further, the upper pressurizing plate 24B and the lower pressurizing plate 24A are not particularly limited as long as they apply pressure to the laminated body S. For example, they may be plate-like materials (heat plates) or flexible sheets that can be heated and cooled. Accordingly, the laminate product can be suitably manufactured. In the first embodiment, each of the upper pressurizing plate 24B and the lower pressurizing plate 24A is a diaphragm formed of a flexible sheet that can be heated and cooled, compressed air is supplied from pneumatic equipment (not shown) to the diaphragm, and the expanded diaphragm applies pressure to the laminated body S.

Further, the vacuum laminating apparatus 11 includes, as a pressing force generation mechanism incorporated into a driving unit (e.g., movable board driving unit), a mechanism for raising or lowering the movable board 23 by raising or lowering a ball screw nut by rotating a ball screw shaft by a servomotor.

With the laminate manufacturing system 1 according to the first embodiment described above, the vacuum pump 15 is disposed below the film unwinding apparatus 10, whereby the installment space in the laminate manufacturing system 1 can be further reduced. Further, at least a part of the vacuum pump 15 is accommodated in the rack L in which the film unwinding apparatus 10 is placed. Specifically, the vacuum pump 15 is disposed below the film unwinding apparatus 10, and is disposed in such a way that at least a part of the vacuum pump 15 is positioned in the rack L in which the film unwinding apparatus 10 is placed. Therefore, it is not necessary to dispose the vacuum pump 15 on the back side of the rack L. Accordingly, the installment space in the laminate manufacturing system 1 can be further reduced. Note that the state in which at least a part of the vacuum pump 15 is disposed in the rack L is a state in which at least a part of the vacuum pump 15 is inside the rack L when the vacuum pump 15 and the rack L are viewed from above, and more preferably a state in which 50% or more of the projection area of the vacuum pump 15 when the vacuum pump 15 is viewed from above is inside the rack L. Further, the state in which the vacuum pump 15 is disposed below the film unwinding apparatus 10 is a state in which at least a part of the vacuum pump 15 and the film unwinding apparatus 10 overlap each other when they are viewed from above.

Further, in the laminate manufacturing system 1, the length of the suction pipe 15A of the vacuum pump 15 can be made shorter and thus the efficiency of vacuuming in the chamber C can be improved compared to the case in which the vacuum pump 15 is disposed in the outside of the rack L in which the film unwinding apparatus 10 is placed. The efficiency of vacuuming in the chamber C can be further improved.

Further, at least a part of the suction pipe 15A extends obliquely with respect to the conveyance direction of the laminated body S. Specifically, the suction pipe 15A extends obliquely as viewed from above from the back side of the chamber C of the vacuum laminating apparatus 11, then extends downwardly, and is coupled to the vacuum pump 15. Accordingly, the length of the suction pipe 15A can be further reduced, and the efficiency of vacuuming in the chamber C can be further improved. Further, at least a part of the suction pipe 15A may include a movable part so as to follow a change in the position of the chamber C. Then, in order to further improve the efficiency of vacuuming in the chamber C, the number of bends of the suction pipe 15A is preferably small. Further preferably, the number of bends of the suction pipe 15A is four or less. However, since various elements and wires are disposed in the inside of the rack L in a three-dimensional manner, it is not easy to minimize the number of bends of the suction pipe 15A and minimize the length of the suction pipe 15A as much as possible. In view of this point, the insertion path of the suction pipe 15A may be determined by inputting the disposition of elements of the laminate manufacturing system 1 into a computer in advance and calculating the insertion path of the suction pipe 15A in which the number of bends of the suction pipe 15A is as small as possible and the length of the suction pipe 15A is as short as possible.

Further, the width from the front side to the back side of the rack L is preferably 1.5 times or more but 3.5 times or less of the width of the carrier film F. Accordingly, the footprint of the laminate manufacturing system 1 can be made small and the installment space in the laminate manufacturing system 1 can be further reduced.

Further, the volume rate of the void in the space surrounded by the rack L is preferably 50 percent or smaller. Accordingly, the size of the rack L can be reduced, the footprint of the laminate manufacturing system 1 can be made small, and the reduction in the production efficiency can be avoided.

Further, the storage box 16 of the pneumatic equipment is disposed in the rack L in which the film unwinding apparatus 10 is placed, the exhaust pipe 15B of the vacuum pump 15 is coupled to the storage box 16, and the exhaust pipe 16A of the storage box 16 is connected to the outside of a clean room in which the laminate manufacturing system 1 is installed. Accordingly, the gas exhausted from the vacuum pump 15 is exhausted to the outside of the clean room through the exhaust pipe 16A along with the gas exhausted from the pneumatic equipment. That is, the exhaustion of the vacuum pump 15 and the exhaustion of the storage box 16 can be unified, and the pipe of the laminate manufacturing system 1 can be simplified.

Further, the storage box 16 is disposed in the upper part of the rack L in which the film unwinding apparatus 10 is placed, and the exhaust pipe 15B of the vacuum pump 15 extends substantially straight upwardly from the vacuum pump 15 and is coupled to the storage box 16. Accordingly, the exhaust resistance of the exhaust pipe 15B is reduced, and the efficiency of the exhaust can be improved.

Further, when the driving source of the pressing force generation mechanism of the laminate manufacturing apparatus is a hydraulic pump, the hydraulic pump, which is the driving source, is disposed on the back side of the laminate manufacturing apparatus since its size is large. Therefore, even when the vacuum pump 15 is disposed below the film unwinding apparatus 10 in such a way that at least a part of the vacuum pump 15 is positioned in the rack L in which the film unwinding apparatus 10 is placed, the effect of saving the space in the laminate manufacturing system 1 is limited. On the other hand, in the laminate manufacturing system 1 according to the first embodiment, a servomotor (electric motor) is used as a driving source of the pressing force generation mechanism of the vacuum laminating apparatus 11 and the flattening press apparatuses 12 and 13. Accordingly, the movable board driving unit into which the pressing force generation mechanism and the servomotor are incorporated can be accommodated in the lower part (lower side of the movable board 23) of the vacuum laminating apparatus 11 and the flattening press apparatuses 12 and 13. Therefore, it is not necessary to dispose the driving source on the back side of the vacuum laminating apparatus 11 or the rack L, whereby the installment space in the laminate manufacturing system 1 can be further reduced.

Further, when a hydraulic pump is used as a driving source of the pressing force generation mechanism of the laminate manufacturing apparatus, since the size of the driving source is large, it is difficult to accommodate the driving source and the movable board driving unit in the lower part of the vacuum laminating apparatus 11 and the flattening press apparatuses 12 and 13, and a pass line (the height at which the carrier film F is conveyed) is normally set to be lower than that in the case where a servomotor is used as the driving source. Therefore, the space below the film unwinding apparatus 10 is narrow, and it is difficult to dispose the vacuum pump 15 below the film unwinding apparatus 10. On the other hand, when a servomotor is used as the driving source, the driving source and the movable board driving unit can be accommodated in the lower part of the vacuum laminating apparatus 11 and the flattening press apparatuses 12 and 13, and the pass line becomes high. Therefore, at least a part of the vacuum pump 15 can be disposed in the space below the film unwinding apparatus 10.

Note that the present disclosure is not limited to the aforementioned embodiment and can be changed as appropriate without departing from the spirit of the present disclosure.

What is claimed is:

1. A laminate manufacturing system comprising:
a pair of carrier films configured to convey a laminated body from one side to another side of the laminate manufacturing system;
a film unwinding apparatus configured to unwind the carrier film;
a laminate manufacturing apparatus that is disposed on the other side of the film unwinding apparatus and presses the laminated body by a pressurizing mechanism in a chamber whose interior is depressurized; and
a film winding apparatus that is disposed on the other side of the laminate manufacturing apparatus and winds the carrier film,
wherein a vacuum pump for depressurizing the interior of the chamber is disposed below the film unwinding apparatus.

2. The laminate manufacturing system according to claim 1, wherein at least a part of the vacuum pump is accommodated in a rack in which the film unwinding apparatus is placed.

3. The laminate manufacturing system according to claim 1, wherein
the vacuum pump is connected to the chamber via a suction pipe, and
at least a part of the suction pipe extends obliquely with respect to a conveyance direction of the laminated body.

4. The laminate manufacturing system according to claim 3, wherein at least a part of the suction pipe includes a movable part to follow a change in a position of the chamber.

5. The laminate manufacturing system according to claim 2, wherein a width from a front side to a back side of the rack is 1.5 times or more but 3.5 times or less of a width of the carrier film.

6. The laminate manufacturing system according to claim 2, wherein a volume rate of a void in a space surrounded by the rack is 50 percent or less.
